(19) United States
(12) Patent Application Publication
(10) Pub. No.: US 2009/0145844 A1
(43) Pub. Date: Jun. 11, 2009

(54) SEQUENCING BATCH MEMBRANE BIOREACTOR AND METHOD THEREOF

(75) Inventors: Kuang Foo Chang, Changhua County (TW); Huey-Song You, Hsinchu (TW); Sheng Hsin Chang, Miaoli County (TW)

Correspondence Address: QUINTERO LAW OFFICE, PC, 2210 MAIN STREET, SUITE 200, SANTA MONICA, CA, 90405, US

(73) Assignee: INDUSTRIAL TECHNOLOGY RESEARCH INSTITUTE, Hsinchu (TW)

(21) Appl. No.: 12/137,398

(22) Filed: Jun. 11, 2008

(30) Foreign Application Priority Data
Dec. 7, 2007 (TW) TW96146783

(51) Int. Cl. C02F 3/00

(52) U.S. Cl. 210/605; 210/202; 210/620; 210/903

(57) ABSTRACT

A sequencing batch membrane bioreactor is provided, comprising a wastewater reservoir, at least one sequencing batch bioreactor, and a membrane reactor. The wastewater reservoir collects and stores wastewater. The sequencing batch bioreactor receives the wastewater in batches from the wastewater reservoir for performing a stirring and aeration process to remove ammonia-based nitrogen, phosphoric ions and organic substance from the wastewater. The membrane reactor is disposed outside of the sequencing batch bioreactor, wherein the wastewater is introduced from the sequencing batch bioreactor to the membrane reactor, treated with solid-liquid separation, and discharged.

### CROSS REFERENCE TO RELATED APPLICATIONS

This application claims priority of Taiwan Patent Application No. 96146783, filed on 7 Dec. 2007, the entirety of which is incorporated by reference herein.

### BACKGROUND OF THE INVENTION

1. Field of the Invention

The invention relates to a sequencing batch membrane bioreactor and method thereof, and more particularly, to a sequencing batch membrane bioreactor and method thereof, wherein the membrane module is completely utilized and disposed outside of the sequencing batch bioreactor for continuous water discharge.

2. Description of the Related Art

Referring to FIG. 1, a conventional sequencing batch membrane bioreactor is shown. The conventional sequencing batch membrane bioreactor 10 comprises a wastewater reservoir 101, a buffer tank 102, and at least one sequencing batch bioreactor 103, and is described in further detail in the following.

The wastewater reservoir 101 is used for collecting and storing wastewater.

The buffer tank 102 is used for receiving wastewater from the wastewater reservoir 101, and adjusting the pH value thereof. Generally, microorganisms grow in a neutral liquid environment (pH value to 6-8). However, wastewater discharged from factories may have different pH values (not always acid or alkaline) due to different processes. Thus, since growth of microorganisms is favorable for wastewater treatment, pH values of factory wastewater must be properly adjusted for microorganisms to grow. Specifically, by properly adjusting pH values of wastewater to maintain a desired pH value for growth of microorganisms, efficient wastewater treatment can be achieved.

The sequencing batch bioreactor 103 receives wastewater from the buffer tank 102 in batches, and sequentially performs treatment processes which include a supply, stirring, aeration and discharge process, and is described in further detail in the following.

For the supply process, wastewater with organic substances (org), ammonia-based nitrogen (NH₃) and phosphoric ions (PO₄³⁻) is introduced from the buffer tank 102 to the sequencing batch bioreactor 103.

For the stirring process, organic substances (org) are provided to reduce the oxidation reduction potential by affecting the metabolism of microorganisms. Thus, nitrate ions (NO₃⁻) in the wastewater turn into nitrogen (N₂) via denitrifying bacteria and is removed from the wastewater. The reaction equation for the stirring process of the wastewater is shown as follows:

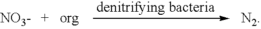

For the aeration process, ammonia-based nitrogen (NH₃) of the wastewater is oxidized by nitrifying bacteria and oxygen (O₂) to generate nitrate ions (NO₃⁻). Then, organic substances (org) left in the wastewater after the stirring process are removed by heterotrophic bacteria, and phosphoric ion (PO₄³⁻) of the wastewater is removed by phosphorus accumulating organisms. The reaction equations for the aeration process of the wastewater are shown as follows:

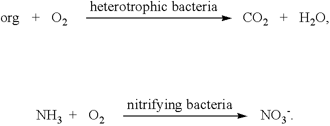

The aeration process and the discharge process are simultaneously performed. For the discharge process, in the sequencing batch bioreactor 103, solid-liquid separation is performed by a membrane module 104 under an aeration environment provided by an aerating tube 105 for the wastewater in which the concentration of nitrate ions (NO₃) is less than a standard value due to oxidation and denitrification reaction. Then, the wastewater is discharged from the sequencing batch bioreactor 103 to complete the treatment process of the sequencing batch bioreactor 103.

For the conventional sequencing batch membrane bioreactor 10, the operating time of each process is strictly controlled and the membrane module 104 is disposed in the sequencing batch bioreactor 103. Thus, because the membrane module 104 is only utilized during the aeration and discharge process, the operating time of the membrane module 104 is minimized, decreasing utility rate and increasing costs.

### BRIEF SUMMARY OF THE INVENTION

A detailed description is given in the following embodiments with reference to the accompanying drawings.

The invention provides a sequencing batch membrane bioreactor comprising a wastewater reservoir, at least one sequencing batch bioreactor, and a membrane reactor. The wastewater reservoir collects and stores wastewater. The sequencing batch bioreactor receives the wastewater in batches from the wastewater reservoir for performing a stirring and aeration process to remove NH₃, PO₄³⁻ and organic substances from the wastewater. The membrane reactor is disposed outside of the sequencing batch bioreactor, wherein the wastewater is introduced from the sequencing batch bioreactor to the membrane reactor, treated with solid-liquid separation, and discharged.

The sequencing batch membrane bioreactor further comprises an acidification reactor receiving the wastewater from the wastewater reservoir, wherein the organic substances in the wastewater are acidified into organic acid and then introduced into the sequencing batch bioreactor.

The acidification reactor comprises a stirrer for stirring the wastewater.

The sequencing batch bioreactor comprises denitrifying bacteria for removing nitric acid-based nitrogen from the wastewater.

The sequencing batch bioreactor comprises heterotrophic bacteria for removing organic substances from the wastewater.

The sequencing batch bioreactor comprises nitrifying bacteria for removing ammonia-based nitrogen from the wastewater.

The sequencing batch bioreactor comprises phosphorus accumulating organisms for removing phosphoric ions from the wastewater.

The membrane reactor comprises a membrane module for performing solid-liquid separation for the wastewater.

The membrane reactor comprises an aerating tube introducing air into the wastewater for performing the aeration process.

The invention also provides a method for a sequencing batch membrane bioreactor comprising introducing wastewater from a wastewater reservoir to an acidification reactor for acidifying organic substances in the wastewater into organic acid, introducing the acidified wastewater into a sequencing batch bioreactor in batches and performing a stirring and aeration process to remove NH₃, PO₄³⁻ and organic substances from the wastewater, and introducing the wastewater into a membrane reactor, performing solid-liquid separation, and then discharging the wastewater.

The acidification reactor comprises a stirrer for stirring the wastewater.

The sequencing batch bioreactor comprises denitrifying bacteria for removing nitric acid-based nitrogen from the wastewater.

The sequencing batch bioreactor comprises heterotrophic bacteria for removing organic substances from the wastewater.

The sequencing batch bioreactor comprises nitrifying bacteria for removing ammonia-based nitrogen from the wastewater.

The sequencing batch bioreactor comprises phosphorus accumulating organisms for removing phosphoric ions from the wastewater.

The membrane reactor comprises a membrane module for performing solid-liquid separation for the wastewater.

The membrane reactor comprises an aerating tube introducing air into the wastewater for performing the aeration process.

### BRIEF DESCRIPTION OF THE DRAWINGS

The present invention can be more fully understood by reading the subsequent detailed description and examples with references made to the accompanying drawings, wherein:

FIG. 1 is a schematic view of a conventional sequencing batch membrane bioreactor.

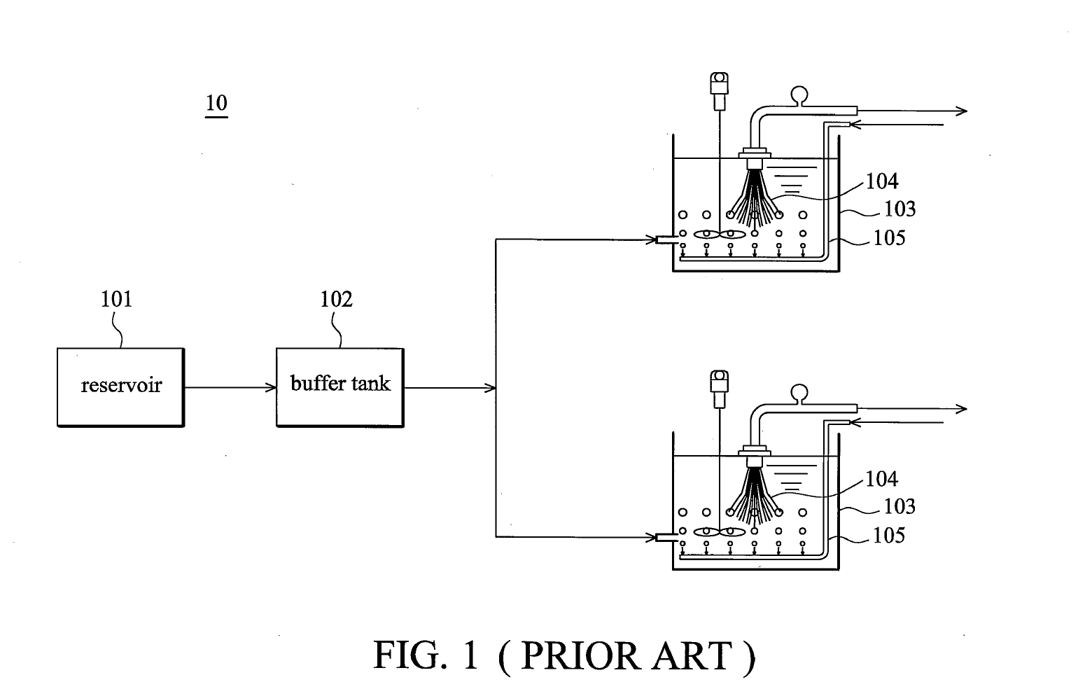

FIG. 2 is a schematic view of a sequencing batch membrane bioreactor in accordance with a first embodiment of the invention.

FIG. 3 is a schematic view of a sequencing batch membrane bioreactor in accordance with a second embodiment of the invention.

FIG. 4 depicts a variation of concentration of total organic carbon (TOC) in each processes of the sequencing batch membrane bioreactor in accordance with the second embodiment of the invention.

FIG. 5 depicts a variation of concentration of ammonia-based nitrogen (NH₃) in each processes of the sequencing batch membrane bioreactor in accordance with the second embodiment of the invention.

FIG. 6 depicts a variation of concentration of phosphoric ions (NO₃⁻) in each processes of the sequencing batch membrane bioreactor in accordance with the second embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

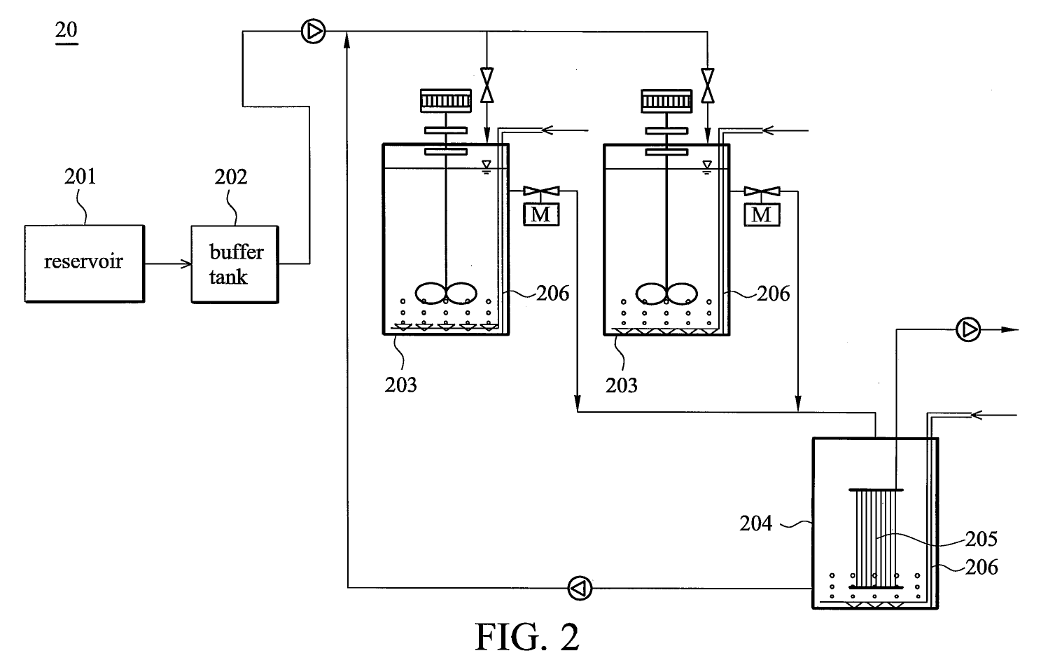

Referring to FIG. 2, a sequencing batch membrane bioreactor of the first embodiment of the invention is shown. The sequencing batch membrane bioreactor 20 comprises a wastewater reservoir 201, a buffer tank 202, at least one sequencing batch bioreactor 203, and a membrane reactor 204, and is described in further detail in the following.

The wastewater reservoir 201 is used for collecting and storing wastewater.

The buffer tank 202 is used for receiving wastewater from the wastewater reservoir 201, and adjusting the pH value thereof. Generally, microorganisms grow in a neutral liquid environment (pH value to 6-8). However, wastewater discharged from factories may have different pH values (not always acid or alkaline) due to different processes. Thus, since growth of microorganisms is favorable for wastewater treatment, pH values of factory wastewater must be properly adjusted for microorganisms to grow. Specifically, by properly adjusting pH values of wastewater to maintain a desired pH value for growth of microorganisms, efficient wastewater treatment can be achieved.

The sequencing batch bioreactor 203 receives wastewater from the buffer tank 202 in sequencing batch for performing a supply, stirring, aeration and discharge process, and is described in further detail in the following.

For the supply process, wastewater with organic substances (org), ammonia-based nitrogen (NH₃) and phosphoric ions (PO₄³⁻) is introduced from the buffer tank 202 to the sequencing batch bioreactor 203.

For the stirring process, organic substances (org) are provided to reduce the oxidation reduction potential by affecting the metabolism of microorganisms. Thus, nitrate ions (NO₃⁻) in the wastewater turn into nitrogen (N₂) via denitrifying bacteria and is removed from the wastewater. The reaction equation for the stirring process of the wastewater is shown as follows:

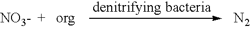

For the aeration process, ammonia-based nitrogen (NH₃) of the wastewater is oxidized by nitrifying bacteria and oxygen (O₂) to generate nitrate ions (NO₃⁻). Then, organic substances (org) left in the wastewater after the stirring process are removed by heterotrophic bacteria, and phosphoric ion (PO₄³⁻) of the wastewater is removed by phosphorus accumulating organisms. The reaction equations for the aeration process of the wastewater are shown as follows:

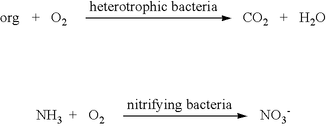

For the discharge process, from the sequencing batch bioreactor 203, solid-liquid separation is performed by a membrane reactor 204 for nitrate ions (NO₃⁻) in the wastewater which are less than a standard value after oxidation and denitrification reaction.

For the membrane reactor 204, following introduction of the wastewater from the sequencing batch bioreactor 203, solid-liquid separation is performed by a membrane module 205 under an aeration environment provided by an aerating tube 206. Then, the wastewater is discharged from the membrane reactor 204, wherein when the wastewater is discharged, sludge in the wastewater is recycled during the supply process in the sequencing batch bioreactor 203. Then, nitrate ions (NO₃⁻) of the wastewater are transformed into nitrogen (N₂) by denitrification in the stirring process to complete the treatment process of the sequencing batch bioreactor 203.

For the sequencing batch membrane bioreactor 20 of the invention, the membrane module 205 is disposed in the membrane reactor 204 on the outside of the sequencing batch bioreactor 203. The wastewater is aerated by the aerating tube 206 so that the wastewater can be continuously discharged from the membrane reactor 204. Thus, the operating time of the membrane reactor 204 is not minimized and utility rate of the membrane module 205 is raised to reduce costs.

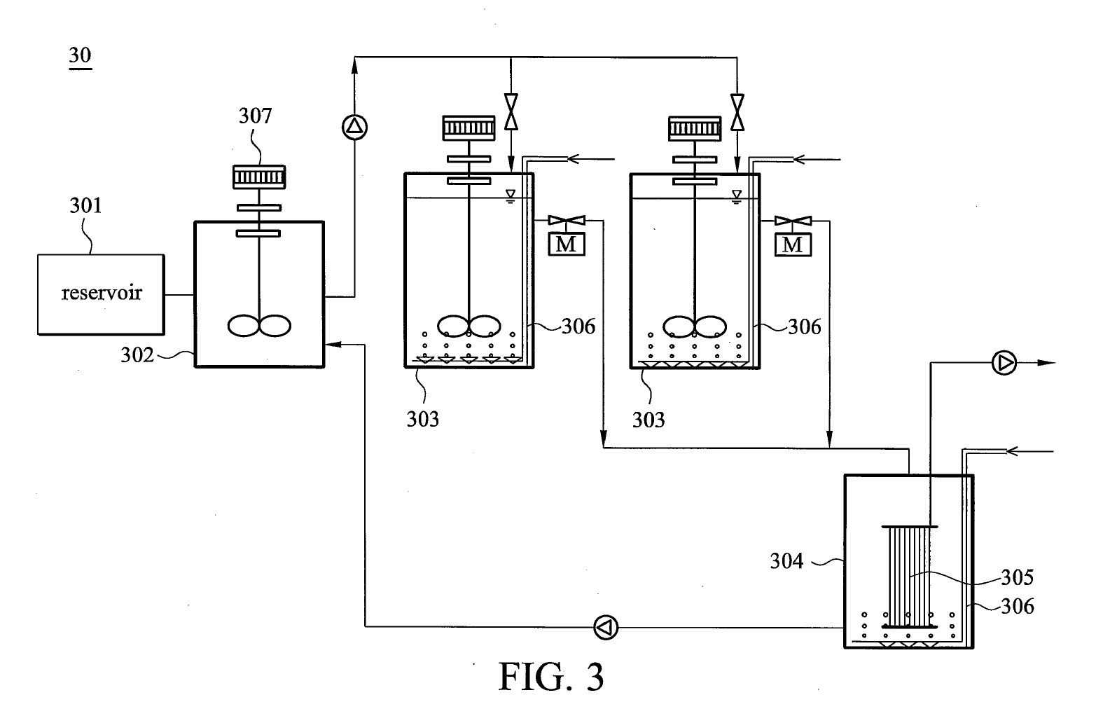

Referring to FIG. 3, a sequencing batch membrane bioreactor of the second embodiment of the invention is shown. The sequencing batch membrane bioreactor 30 comprises a wastewater reservoir 301, an acidification reactor 302, at least one sequencing batch bioreactor 303, and a membrane reactor 304, and is described in further detail in the following.

Wastewater Reservoir 301:

The wastewater reservoir 301 is used for collecting and storing wastewater.

Acidification Reactor 302:

The acidification reactor 302 is used for receiving wastewater from the wastewater reservoir 301, wherein the organic substances in the wastewater insusceptible to decomposition are acidified into organic acid. In detail, microorganisms in the acidification reactor 302 and the wastewater are uniformly mixed by a stirrer 307 to raise the decomposing efficiency for transforming macromolecule organic substances into small molecule organic acid (e.g. formic acid, acetic acid, propionic acid, and butyric acid). Thus, the acidification reactor 302 reduces the time it takes to decompose the organic substances, making the entire process more efficient.

Sequencing Batch Bioreactor 303:

The sequencing batch bioreactor 303 receives wastewater from the acidification reactor 302 in batches for performing a supply, stirring, aeration and discharge process, and is described in further detail in the following.

For the supply process, the wastewater with organic substances (org), ammonia-based nitrogen (NH₃) and phosphoric ions (PO₄³⁻) is introduced from the acidification reactor 302 to the sequencing batch bioreactor 303.

For the stirring process, organic substances (org) are provided to reduce the oxidation reduction potential by affecting the metabolism of microorganisms. Thus, nitrate ions (NO₃⁻) in the wastewater turn into nitrogen (N₂) via denitrifying bacteria and is removed from the wastewater. The reaction equation for the stirring process of the wastewater is shown as follows:

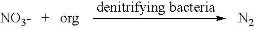

For the aeration process, ammonia-based nitrogen (NH₃) of the wastewater is oxidized by nitrifying bacteria and oxygen (O₂) to generate nitrate ions (NO₃⁻). Then, organic substances (org) left in the wastewater after the stirring process are removed by heterotrophic bacteria, and phosphoric ion (PO₄³⁻) of the wastewater is removed by phosphorus accumulating organisms. The reaction equations for the aeration process of the wastewater are shown as follows:

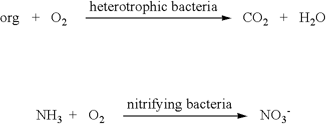

For the discharge process, from the sequencing batch bioreactor 303, solid-liquid separation is performed by a membrane reactor 304 for nitrate ions (NO₃⁻) in the wastewater which are less than a standard value after oxidation and denitrification reaction.

Membrane Reactor 304:

For the membrane reactor 304, following introduction of the wastewater from the sequencing batch bioreactor 303, solid-liquid separation is performed by a membrane module 305 under an aeration environment provided by an aerating tube 306. Then, the wastewater is discharged from the membrane reactor 304, wherein when the wastewater is discharged, sludge in the wastewater is recycled during the supply process in the sequencing batch bioreactor 303. Then, nitrate ions (NO₃⁻) of the wastewater are transformed into nitrogen (N₂) by denitrification in the stirring process to complete the treatment process of the sequencing batch bioreactor 303.

For the sequencing batch membrane bioreactor 30 of the invention, the membrane module 305 is disposed in the membrane reactor 304 on the outside of the sequencing batch bioreactor 303 and the convectional buffer tank 102 is replaced by the acidification reactor 302. Also, the acidification reactor 302 is used for acidifying wastewater which contains carbon sources insusceptible to biological decomposition, thereby raising denitrification efficiency, making the entire process more efficient.

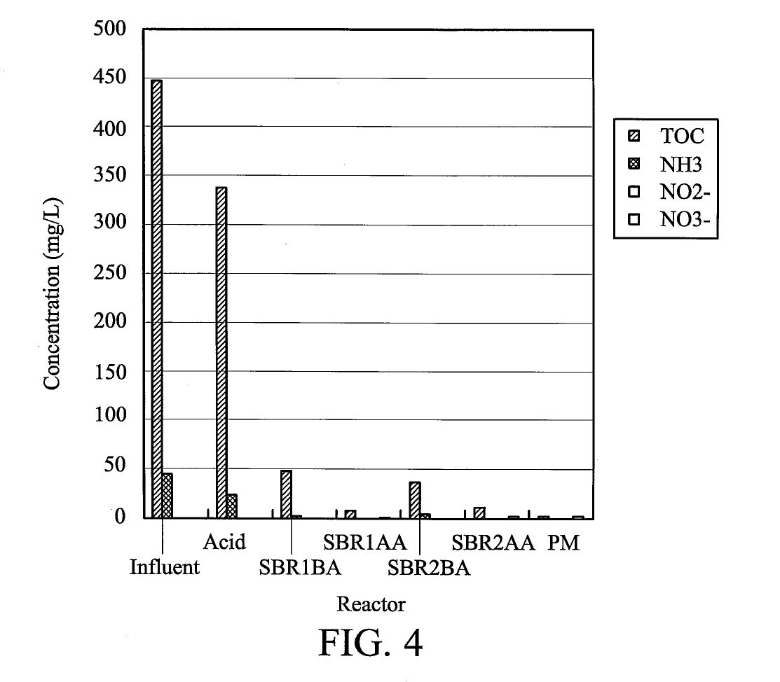

FIG. 4 shows experimental data of the wastewater in the sequencing batch membrane bioreactor of the second embodiment of the invention, including variations of concentration of total organic carbon (TOC), ammonia-based nitrogen (NH₃), nitrite ions (NO₂⁻), and nitrate ions (NO₃⁻) in each process. In FIG. 4, “Influent” indicates concentration of the influent, “Acid” indicates concentration of the wastewater in the acidification reactor, “SBR1-BA” is concentration of the wastewater in a first sequencing batch bioreactor before aeration, “SBR1-AA” is concentration of the wastewater in the first sequencing batch bioreactor after aeration, “SBR2-BA” is concentration of the wastewater in a second sequencing batch bioreactor before aeration, “SBR2-AA” is concentration of the wastewater in the second sequencing batch bioreactor after aeration, and “PM” is concentration of the discharged wastewater. The variations of concentration of total organic carbon (TOC) in each process were analyzed and are explained in the following.

Concentration of total organic carbon (TOC) of the wastewater which was not introduced into the acidification reactor is the concentration of influent (indicated as “Influent”) and concentration of total organic carbon (TOC) of the wastewater which was introduced into the acidification reactor is concentration of the wastewater in the acidification reactor (Acid). In the process, denitrification was produced due to nitrate ions (NO₃⁻) in the sludge recycled from the membrane reactor, and some of the total organic carbons (TOC) were utilized. The concentration of total organic carbon (TOC) of the wastewater was reduced by around 100 mg/L.

After the wastewater was introduced into the first and second sequencing batch bioreactors, denitrification was continuously produced. The concentrations of total organic carbon (TOC) of the wastewater of the first and second sequencing batch bioreactors (SBR1-BA, SBR2-BA) were around 50 mg/L.

For the aeration process, the remaining total organic carbon (TOC) of the wastewater was processed with heterotrophic bacteria. Thus, the concentrations of total organic carbon (TOC) of the wastewater of the first and second sequencing batch bioreactors (SBR1-AA, SBR2-AA) were reduced to about 20 mg/L.

Concentration of total organic carbon (TOC) of the wastewater which was treated with solid-liquid separation and discharged from the membrane reactor was less than 10 mg/L.

Therefore, around 97 percent of total organic carbon (TOC) of the wastewater was removed by the sequencing batch membrane bioreactor of the invention.

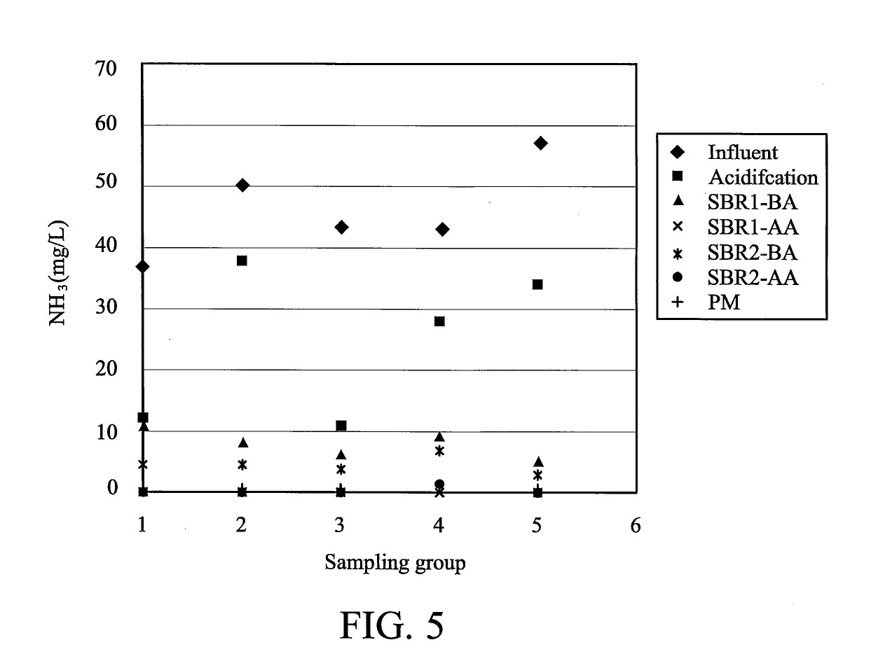

FIG. 5 shows experimental data of the wastewater in the sequencing batch membrane bioreactor of the second embodiment of the invention, including variations of concentration of ammonia-based nitrogen (NH₃) in each process. In FIG. 5, “Influent” indicates concentration of the influent, “Acid” indicates concentration of the wastewater in the acidification reactor, “SBR1-BA” is concentration of the wastewater in a first sequencing batch bioreactor before aeration, “SBR1-AA” is concentration of the wastewater in the first sequencing batch bioreactor after aeration, “SBR2-BA” is concentration of the wastewater in a second sequencing batch bioreactor before aeration, “SBR2-AA” is concentration of the wastewater in the second sequencing batch bioreactor after aeration, and “PM” is concentration of the discharged wastewater. The variations of concentration of ammonia-based nitrogen (NH₃) in each process were analyzed and are explained in the following.

Concentration of ammonia-based nitrogen (NH₃) of the wastewater which was not introduced into the acidification reactor is the concentration of influent (indicated as “Influent”) and concentration of ammonia-based nitrogen (NH₃) of the wastewater which was introduced into the acidification reactor is concentration of the wastewater in the acidification reactor (Acid). After the wastewater was introduced into the acidification reactor, concentration of ammonia-based nitrogen (NH₃) of the wastewater was diluted and reduced from around 50 mg/L to 40 mg/L.

After the wastewater was introduced into the first and second sequencing batch bioreactors, concentration of ammonia-based nitrogen (NH₃) of the wastewater before the aeration process was around 10 mg/L due to the dilution effect.

For the aeration process, the ammonia-based nitrogen (NH₃) was transformed into nitrate ions (NO₃⁻) by nitrifying bacteria. Thus, concentrations of ammonia-based nitrogen (NH₃) of the wastewater of the first and second sequencing batch bioreactors (SBR1-AA, SBR2-AA) after the aeration process were reduced to amounts not within the detection range of the detection instrument used.

Similarly, concentration (PM) of ammonia-based nitrogen (NH₃) of the wastewater which was treated with solid-liquid separation and discharged from the membrane reactor was not detected.

Therefore, ammonia-based nitrogen (NH₃) of the wastewater was removed by the sequencing batch membrane bioreactor of the invention and amount of nitrate ions (NO₃⁻) in the wastewater which was treated with solid-liquid separation was significantly less than the standard value.

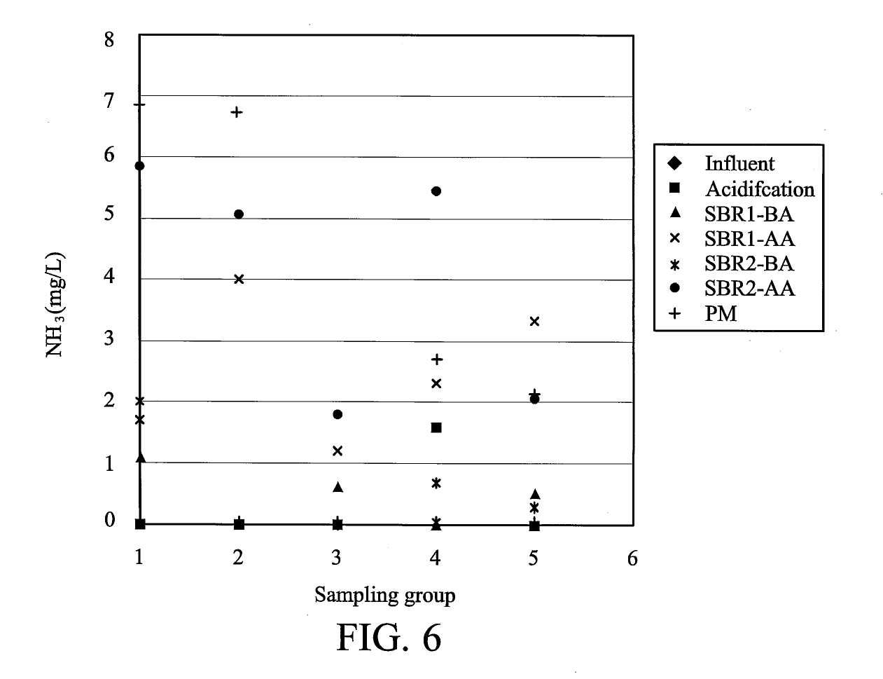

FIG. 6 shows experimental data of the wastewater in the sequencing batch membrane bioreactor of the second embodiment of the invention, including variations of concentration of nitrate ions (NO₃⁻) in each process. In FIG. 6, “Influent” indicates concentration of the influent, “Acid” indicates concentration of the wastewater in the acidification reactor, “SBR1-BA” is concentration of the wastewater in a first sequencing batch bioreactor before aeration, “SBR1-AA” is concentration of the wastewater in the first sequencing batch bioreactor after aeration, “SBR2-BA” is concentration of the wastewater in a second sequencing batch bioreactor before aeration, “SBR2-AA” is concentration of the wastewater in the second sequencing batch bioreactor after aeration, and “PM” is concentration of the discharged wastewater. The variations of concentration of nitrate ions (NO₃⁻) in each process were analyzed and are explained in the following.

Concentration of nitrate ions (NO₃⁻) of the wastewater which was not introduced into the acidification reactor is the concentration of influent (indicated as “Influent”) and concentration of nitrate ions (NO₃⁻) of the wastewater which was introduced into the acidification reactor is concentration of the wastewater in the acidification reactor (Acid). Before the wastewater was introduced into the acidification reactor, concentration of nitrate ions (NO₃⁻) of the wastewater was not detected because the wastewater in the wastewater reservoir contained no nitrate ions (NO₃⁻). After the wastewater was introduced into the acidification reactor, the recycled sludge containing nitrate ions (NO₃⁻) underwent deoxygenation. Thus, concentration of nitrate ions (NO₃⁻) of the wastewater were reduced to amounts not within the detection range of the detection instrument used.

Before the aeration process, concentrations of nitrate ions (NO₃⁻) of the wastewater in the first sequencing batch bioreactor (SBR1-BA) and the second sequencing batch bioreactor (SBR2-BA) were not detected.

After the aeration process, nitrate ions (NO₃⁻) were produced by nitrification of nitrifying bacteria on ammonia-based nitrogen (NH₃). Thus, concentrations of nitrate ions (NO₃⁻) of the wastewater in the first sequencing batch bioreactor (SBR1-AA) and the second sequencing batch bioreactor (SBR2-AA) were around 4-6 mg/L.

Concentration (PM) of nitrate ions (NO₃⁻) of the wastewater which was treated with solid-liquid separation and discharged from the membrane reactor was around 4-6 mg/L.

Therefore, around 91 percent of nitrate ions (NO₃⁻) of the wastewater were removed by the sequencing batch membrane bioreactor of the invention.

The experimental data in FIG. 4 to FIG. 6 show that the sequencing batch membrane bioreactor of the invention improved the ammonia-based nitrogen (NH₃) and total organic carbon (TOC) treatment results.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A sequencing batch membrane bioreactor comprising:
a wastewater reservoir collecting and storing wastewater;
at least one sequencing batch bioreactor receiving the wastewater in batches from the wastewater reservoir for performing a stirring and aeration process to remove ammonia-based nitrogen, phosphoric ions and organic substance from the wastewater; and
a membrane reactor disposed outside of the sequencing batch bioreactor, wherein the wastewater is introduced from the sequencing batch bioreactor to the membrane reactor, treated with solid-liquid separation, and discharged.

2. The sequencing batch membrane bioreactor as claimed in claim 1 further comprising an acidification reactor receiving the wastewater from the wastewater reservoir, wherein the organic substances in the wastewater are acidified into organic acid and then the wastewater is introduced into the sequencing batch bioreactor.

3. The sequencing batch membrane bioreactor as claimed in claim 2, wherein the acidification reactor comprises a stirrer for stirring the wastewater.

4. The sequencing batch membrane bioreactor as claimed in claim 1, wherein the sequencing batch bioreactor comprises denitrifying bacteria, and removing nitric acid-based nitrogen from the wastewater.

5. The sequencing batch membrane bioreactor as claimed in claim 1, wherein the sequencing batch bioreactor comprises heterotrophic bacteria for removing organic substances from the wastewater.

6. The sequencing batch membrane bioreactor as claimed in claim 1, wherein the sequencing batch bioreactor comprises nitrifying bacteria for removing ammonia-based nitrogen from the wastewater.

7. The sequencing batch membrane bioreactor as claimed in claim 1, wherein the sequencing batch bioreactor comprises phosphorus accumulating organisms for removing phosphoric ions from the wastewater.

8. The sequencing batch membrane bioreactor as claimed in claim 1, wherein the membrane reactor comprises a membrane module for performing solid-liquid separation for the wastewater.

9. The sequencing batch membrane bioreactor as claimed in claim 1, wherein the membrane reactor comprises an aerating tube introducing air into the wastewater for performing the aeration process.

10. A dealing method of a sequencing batch membrane bioreactor comprising:
(1) introducing the wastewater from a wastewater reservoir to an acidification reactor for acidifying organic substances in the wastewater into organic acid;
(2) introducing the acidified wastewater into a sequencing batch bioreactor in batches and performing a stirring and aeration process to remove NH₃, PO₄³⁻ and from the wastewater; and
(3) introducing the wastewater into a membrane reactor, performing solid-liquid separation, and then discharging the wastewater.

11. The dealing method of the sequencing batch membrane bioreactor as claimed in claim 10, wherein the acidification reactor comprises a stirrer for stirring the wastewater.

12. The dealing method of the sequencing batch membrane bioreactor as claimed in claim 10, wherein the sequencing batch bioreactor comprises denitrifying bacteria, and removing nitric acid-based nitrogen from the wastewater.

13. The dealing method of the sequencing batch membrane bioreactor as claimed in claim 10, wherein the sequencing batch bioreactor comprises heterotrophic bacteria for removing organic substances from the wastewater.

14. The dealing method of the sequencing batch membrane bioreactor as claimed in claim 10, wherein the sequencing batch bioreactor comprises nitrifying bacteria for removing ammonia-based nitrogen from the wastewater.

15. The dealing method of the sequencing batch membrane bioreactor as claimed in claim 10, wherein the sequencing batch bioreactor comprises phosphorus accumulating organisms for removing phosphoric ions from the wastewater.

16. The dealing method of the sequencing batch membrane bioreactor as claimed in claim 10, wherein the membrane reactor comprises a membrane module for performing solid-liquid separation for the wastewater.

17. The dealing method of the sequencing batch membrane bioreactor as claimed in claim 10, wherein the membrane reactor comprises an aerating tube introducing air into the wastewater for performing the aeration process.
